(19) United States
(12) Patent Application Publication
(10) Pub. No.: US 2011/0006968 A1
(43) Pub. Date: Jan. 13, 2011

(54) BAYLYN ANTENNA MOUNTING APPARATUS AND SYSTEM

(76) Inventor: Kevin Allen Morrow, Richmond, VA (US)

Correspondence Address: GOODWIN PROCTER LLP, 901 NEW YORK AVENUE, N.W., WASHINGTON, DC, 20001, US

(21) Appl. No.: 12/502,042

(22) Filed: Jul. 13, 2009

(51) Int. Cl. H01Q 3/02; F16M 13/00

(52) U.S. Cl. 343/882; 248/514

(57) ABSTRACT

An antenna mounting apparatus and system is provided for quick and easy installation and removal of antennas that can be utilized with mounting devices and systems. The present apparatus and system allows for a one time routing of transmission medium from the antenna mount, by attaching to a rotatable female connector within the base of the mount, thereby allowing the cable to move freely. This prevents loss of connection as the connector is threaded into the male portion of the upper mount assembly. The barrel assembly may contain a male pin connector threaded within the chamber of the barrel connected to the antenna. The female barrel assembly may then thread onto the male lower assembly where the male and female connectors will adjoin, thus creating a solid connection point with the set screw which will serve to eliminate a loss of conductive connection and reduce theft.

### BACKGROUND

1. Field of the Invention

The present invention relates generally to marine antenna mounts for watercraft, recreational vehicles and the like. More specifically, the present invention relates to a mounting apparatus and system that provides for the quick and simple installation of antennas and the quick and simple removal of damaged antennas.

Antennas and associated mounting systems are commonly mounted externally and vertically on watercraft, recreational vehicles and the like. The external and vertical mounting usually affords antennas a more suitable range and propagation path for sending and receiving signals.

Numerous applications and advantages may be utilized by the present antenna mounting apparatus and system, for example, with vertical, fixed, or variable position mounts, and so forth. In addition, the improved mounting apparatus and system may be compatible with, but not limited to, commonly used transmission media such as coaxial cable and/or other conventional telecommunications wiring.

2. Description of the Related Art

In recent decades, there has been much advancement with the development of television and radio systems such as, for example, CB radios, sea to shore radios, etc. The modern day developments of mobile communications navigational aids have led to an increased need for an external UHF/VHF antenna on an external mount to facilitate maximum reception.

A vast array of antennas, antenna mounts, and associated systems are commonly used throughout the world, and have thus far been developed over the years to accommodate the needs of such equipment.

Due to the unforgiving nature of the fixed position, variable position, or any other type of mount, antennas are often damaged when passing underneath low lying structures. The effects of the damage can often result in antenna failure. This failure is often due to a bad connection or a faulty or damaged antenna. The antenna failure itself is not always necessarily in the transmission medium or coaxial cable/wiring itself. However, due to the antenna failure, the owner of the vessel often must remove and replace the entire antenna system.

Such removal, replacement, or repair can be costly to the owner because it typically requires a technician for the removal, installation, and repair of the antenna mounting system. The technician must also remove and install the coaxial cable or wiring that has been routed, secured, and connected to the equipment within the vessel.

Although in-line splitters may be used to mitigate the cost of replacement, these often change the impedance of such antenna systems and are typically installed incorrectly. When in-line splitters are installed incorrectly, the purchase of a whole new system is often required.

In addition, a further problem in this field is that the antenna and its internal components are often exposed to the elements. The quality, and therefore the expense of the antenna often determines how well the antenna and its internal components are protected from moisture and the elements resulting in corrosion within the antenna housing.

### SUMMARY OF EXEMPLARY ASPECTS OF THE ADVANCEMENTS

Accordingly, an apparatus and associated system is provided that is directed towards solving the aforementioned issues faced by consumers. These issued are solved by eliminating the need to hire costly professional services required to remove and replace antennas and cabling/wiring by allowing the installer to replace the damaged antenna rather than replace the entire system.

In one exemplary aspect of the current invention, an antenna mounting apparatus is provided with an upper base mount notched or gear mesh ridged pivotal head, the upper base pivotal head including an internal housing thread and an outer thread. A female threaded connector assembly is also provided, the female threaded connector assembly including a flanged rotatable solder point and an outside connector thread, the outside connector thread to be fastened into the internal housing thread of the upper base pivotal head.

In addition an upper barrel assembly is provided including a hollow barrel housing and a flanged male pin threaded assembly, the hollow barrel housing containing an internal thread, and the flanged male pin threaded assembly containing an outer thread, such that the flanged male pin threaded assembly may be fastened to the hollow barrel housing.

In another exemplary aspect of the current invention, the upper barrel assembly is fastened to the outer thread of the upper base pivotal head.

In another exemplary aspect of the current invention, a primary conductive core path is established by soldering an inner conductive core of the transmission medium to the flanged rotatable solder point of the female threaded connector assembly.

In yet another exemplary aspect of the current invention, a secondary conductive path is established by the hollow barrel housing as a connection point between the antenna and the upper base pivotal head.

In another exemplary aspect of the current invention, a thumb hollow barrel is provided with a thread type connector used to connect the upper base pivotal head to the transmission medium.

In yet another exemplary aspect of the current invention, the antenna is adjoined to the upper barrel assembly and is affixed in place by use of a set screw.

In still a further exemplary aspect of the current invention, the outside conductor thread of the female threaded connector assembly contains a non-conductive isolation.

In another exemplary aspect of the current invention, a system is provided for electrical connection of an antenna to a transmission medium. The system includes a pedestal mounting base, an antenna mount, and a two axis pivotal point. The two axis pivotal point may be adjoined to the pedestal mounting base and adjoined to the antenna mount in such a manner to allow the antenna mount to be positioned and locked in multiple positions.

In yet another exemplary aspect of the current invention, the antenna mount is utilized with vertical, fixed, and/or variable position mounts.

In yet another exemplary aspect of the current invention, the transmission medium is coaxial cable, wire, or any other transmission medium.

It is a feature of the present invention to provide a sealed connection point incorporated within the antenna mount head assembly to eliminate corrosion and theft.

It is another feature to provide an antenna mounting system compatible with most, if not all, mounts currently manufactured in use today, as well as any future mounts by mounting to the pivotal or fixed adjoining point of said mount.

It is yet another feature of the present invention that will allow the one time routing of coaxial cable/wiring routed and secured from or near the mount assembly to the equipment within the vessel.

It is to be understood that both the foregoing general description of the invention and the following detailed description are exemplary, but are not restrictive, of the invention.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings, wherein:

FIG. 1 illustrates a schematic exploded view of the present invention's internal components, and how the present invention will assemble with an existing variable position lever mount;

FIG. 2 illustrates a schematic representation of the present invention with antenna barrel chamber assembled and a schematic breakdown of how it provides a sealed connection point between the antenna and the mount head assembly; and

FIG. 3 illustrates a diagram of an assembled view of the internal components of the present invention.

### DETAILED DESCRIPTION

The features of the present invention disclosed in the specification, the claims and/or in the accompanying drawings, may, both separately, and in any combination thereof, be material for realizing the invention in various forms thereof. Reference to the drawings are for the purposes of illustrating the embodiments of the invention only, and not for limiting of the same and its application or its usage.

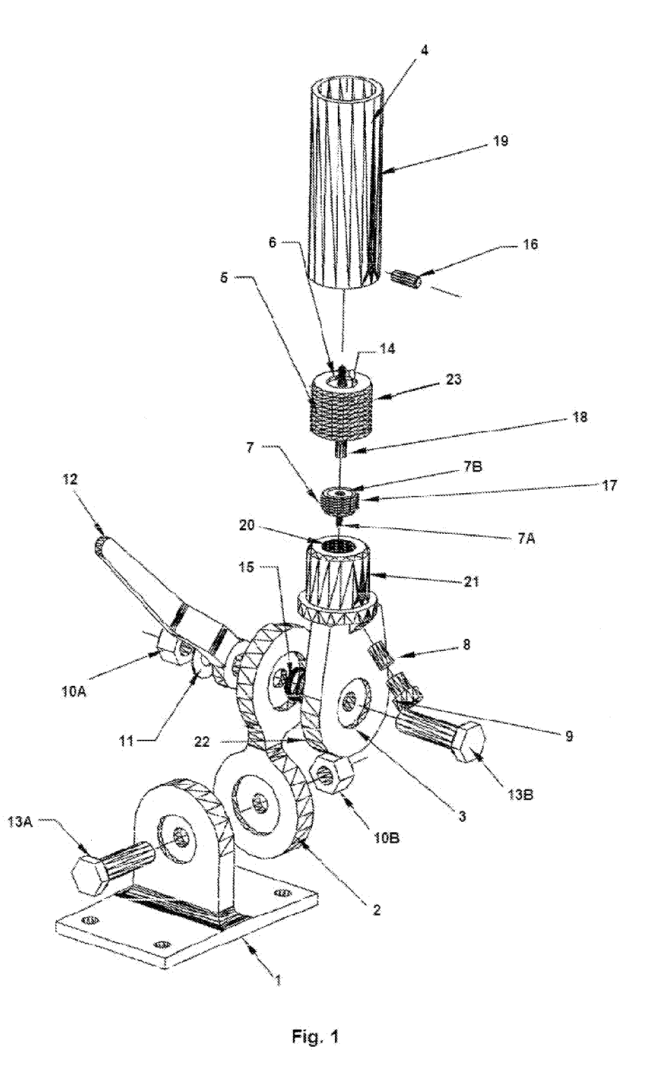

FIG. 1 illustrates an exploded breakdown of an exemplary aspect of the present invention incorporated with an existing mount as a reference only, and not to limit its application and usage thereof. A pedestal mounting base 1 with an upstanding semi-circular, notched or gear mesh ridged upper head is adjoined to the lower notched or gear mesh ridged pivotal head of a two axis pivotal point 2 by a bolt 13A that is inserted through the bore of the pedestal mounting base 1.

The bolt 13A is also inserted through the bore of the lower portion of the two axis notched or gear meshed ridged pivotal point 2 and secured by a lock nut 10B, thereby creating a mechanism for that portion of the mount assembly allowing the lower portion to be quickly positioned and locked in multiple positions by means of the meshing of the gear ridging by tightening or loosening the lock nut 10B.

The upper base mount notched or gear mesh ridged pivotal head 3 is adjoined to the upper pivotal notched or gear mesh ridged head of the two axis pivot point 2 by inserting a bolt 13B through the bore of the upper base mount notched or gear mesh ridged pivotal head 3, a spring 15 through the bore of the upper notched or gear mesh ridged pivotal head of the two axis pivotal point 2, and then a cam-lock lever 12. Then, a washer 11 is secured by a lock nut 10A, thereby creating a mechanism allowing the upper assembly to be quickly positioned and locked in multiple positions. This can be accomplished by meshing the notched or gear mesh ridging 22 of the upper base mount pivotal head 3 with the gear mesh ridging of the upper pivotal head of the two axis pivotal point 2 by tightening and loosening the cam-lock lever 12.

In this exemplary embodiment, the coaxial cable 8 has the cable shielding folded over the cable 8 itself and inserted through the thumb hollow barrel 9 with thread, where the inner conductive core of the coaxial cable 8 is soldered to the flanged rotatable solder point 7A of the female threaded connector assembly 7, thereby establishing the primary conductive core path. The outside connector thread 17 of the female threaded connector assembly 7 contains a non-conductive insulation 7B. The female threaded connector assembly 7 is screwed into the upper threaded chamber of the upper base mount notched or gear mesh ridged pivotal head 3, where the internal housing thread 20 of the upper base mount pivotal head 3 and the outside connector thread 17 will screw together, thereby creating the adjoining connection point for the mount portion of the antenna assembly.

The exposed shielding of the coaxial cable 8 meets with the thumb hollow barrel 9 with an external thread, which is then screwed into place creating a secondary conductive path by means of the mount itself However, the present invention may also be accomplished without the use of the thumb hollow barrel 9 with thread.

The antenna's coaxial cable/wiring's shielding is contained within the upper barrel assembly. The shielding is connected to the solder point of the secondary conductive path 14, as it is connected to the outer thread 5 of the flanged male pin threaded assembly 23 and screwed into the internal thread 19 of the hollow barrel housing 4 of the antenna barrel assembly. This has the effect of creating a secondary path for the upper assembly by means of the mount assembly itself by using the hollow antenna barrel assembly housing 4 as the connection point for the secondary conductive path between the antenna and the upper base mount notched or gear mesh ridged pivotal head assembly 3.

The inner conductive core of the coaxial cable 8 from the antenna is soldered to the flanged rotatable upper solder point 18 of the flanged male pin threaded assembly 23, thereby establishing a primary conductive path separated by a non-conductive isolator 6 contained within an outside connector thread housing. The antenna housing itself is set in place atop and is affixed inside the hollow barrel chamber 4 of the upper portion of the antenna barrel assembly by epoxy or other means necessary to establish a sealed enclosure.

The antenna barrel assembly is then screwed onto the outer thread 21 of the upper mount head assembly 3, thereby creating a sealed union of the flanged lower connector point 18 of the flanged male pin threaded assembly 23 to the flanged female connection point of the female threaded connector assembly 7 of the upper mount notched or gear mesh ridged pivotal head assembly 3.

This exemplary arrangement establishes a complete mounting apparatus and system with necessary conductive paths between the inner primary conductive core conductive path as well as the external secondary path established by utilizing the hollow antenna barrel assembly housing 4 as the secondary conductive path. The set screw 16, is then threaded into the bore of the antenna housing assembly 4, and a countersink or bore of the outer thread 21, to lock the adjoining parts in place, thus creating a locking point that will act as a theft deterrent, as well as preventing the inadvertent separation of adjoining connector points of the upper base mount pivotal head 3 and the antenna housing assembly 4.

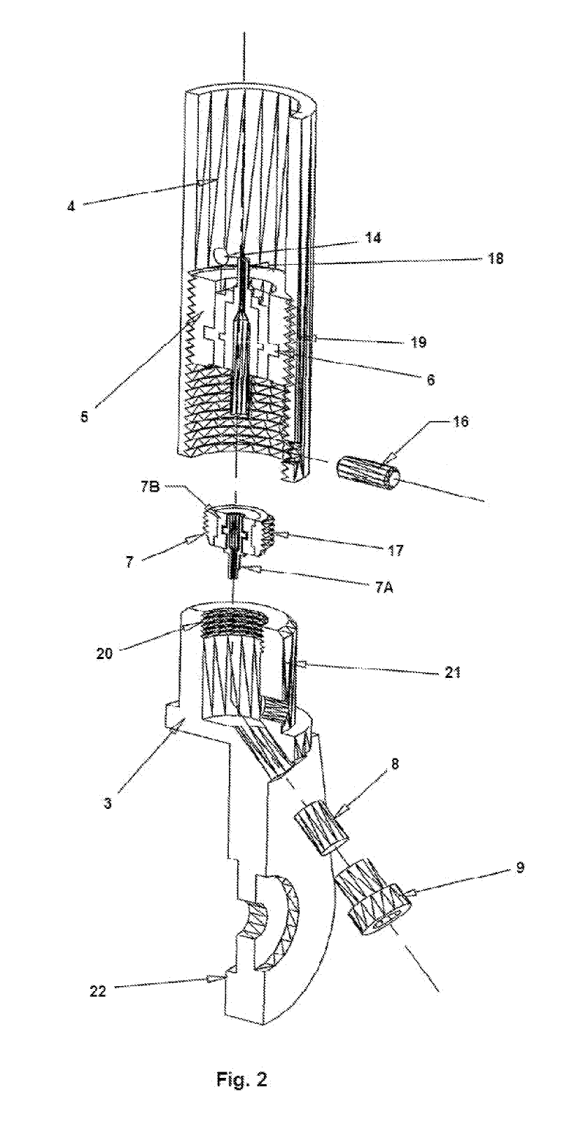

FIG. 2 illustrates the partial view of an exemplary aspect of the present invention adapted for use with, but not limited to, multiple position mounts. As can be seen, the coaxial cable 8 has the cable shielding folded over the cable itself and inserted through the thumb hollow barrel 9 with an external thread. The inner conductive core of the coaxial cable is soldered to the female pin of the flanged rotatable solder point 7A of the female threaded connector assembly 7, thereby establishing the primary conductive core path.

The outside connector thread 17 of the female threaded connector assembly 7 containing a non-conductive insulation 7B and a flanged rotatable female conductor point 7A is screwed into the upper threaded chamber of the upper base mount notched or gear mesh ridged pivotal head 3. The internal housing thread 20 of the upper base mount notched or gear mesh ridged pivotal head 3 and the outside connector thread 17 will screw together within the upper base mount notched or gear mesh ridged pivotal head 3.

The thumb hollow barrel 9 with external thread is screwed in place allowing it to make contact with the exposed shielding of the coaxial cable 8, thus creating a secondary conductive path by means of the mount itself. However, the exemplary aspect of the invention may be realized without the use of the thumb hollow barrel 9 with the external thread.

The antenna's coaxial cable/wiring's shielding is contained within the upper barrel assembly, and is connected to the solder point of the secondary conductive path 14, as it is connected to the outer thread 5 of the flanged male pin threaded assembly 23 and screwed into the internal thread 19 of the hollow barrel housing 4 of the antenna barrel assembly.

This facilitates the creation of a secondary path for the upper assembly by means of the mount assembly itself by using the hollow antenna barrel assembly housing 4 as the connection point for the secondary conductive path between the antenna and the upper base mount notched or gear mesh ridged pivotal head assembly 3. The inner conductive core of the coaxial cable from the antenna is soldered to the upper flanged rotatable male pin solder point 18 of the male pin threaded assembly 23, establishing a primary conductive path.

The primary conductive path is separated from the secondary conductor path by a non-conductive isolator 6 contained within the external connector thread housing 17, which is threaded into the internal thread 19 of the housing of the antenna barrel assembly 4. The antenna itself is set in place atop and slips inside the hollow barrel chamber 4 of the upper portion of the antenna barrel assembly by epoxy or other means necessary to establish a sealed enclosure.

The antenna barrel assembly is then screwed onto the outer thread 21 of the upper mount notched or gear mesh ridged pivotal head assembly 3, thereby creating a sealed union of the lower flanged rotatable male pin connector point 18 the male pin threaded assembly 23 to the female connection point of a flanged rotatable female conductor 7A of the female threaded connector assembly 7 of the upper mount notched or gear mesh ridged pivotal head assembly 3.

This exemplary arrangement establishes a complete mounting apparatus and system with necessary conductive paths between the inner primary conductive core conductive paths as well as the external secondary path established by utilizing the hollow antenna barrel assembly housing 4. The set screw 16, is then threaded into the bore of the antenna housing assembly 4, and a countersink or bore of the outer thread 21, to lock the adjoining parts in place. This arrangement thus creates a locking point that will act as a theft deterrent, as well as prevent the inadvertent separation of adjoining connector points of the upper base mount notched or gear mesh ridged pivotal head 3 and the antenna housing assembly 4.

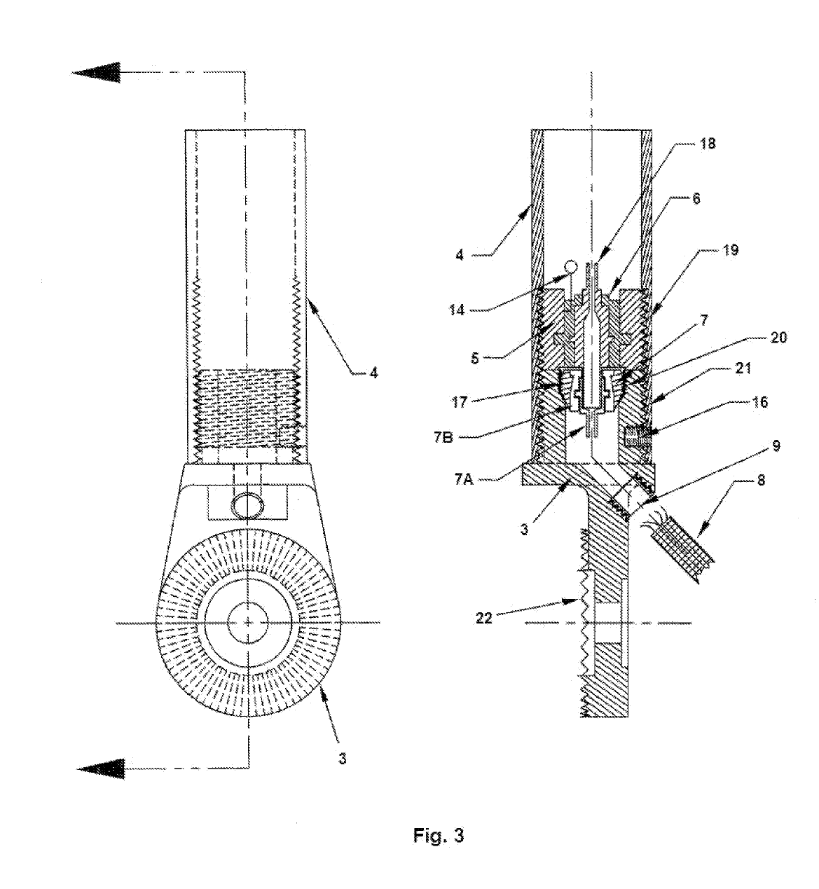

FIG. 3 illustrates the two conductive path application, for the sake of reference only, and not to limit its application and usage thereof. For example, the following invention may be used with one or more conductive paths.

As can be seen by the sectional assembled view of the present invention, the embodiment of the internal components may be integrated together as a single working unit. The notched or gear mesh ridging 22 of the upper base mount pivotal head 3 allows it to interlock with the gear mesh ridging of the upper pivotal head 2 of the two axis pivotal point.

In this exemplary embodiment, the coaxial cable 8 illustrates the cable shielding folded over the cable itself as it is inserted through the thumb hollow barrel 9 with external thread, which is shown pre-threaded into the upper base mount pivotal head 3. In addition, the inner conductive core of the coaxial cable 8 is soldered to the flanged rotatable solder point 7A of the female threaded connector assembly 7.

The upper flanged rotatable male connector pin 18 has been soldered to the inner conductive core of the coaxial cable 8 of the antenna and its housing has been inserted and set in place by epoxy or other means, thus creating the primary conductive core of the unit. The non-conductive isolator 7B of the female threaded connector assembly 7, and the non conductive isolator 6 of the male pin threaded assembly 23 will separate the conductive paths.

The outside connector thread 17 of the female threaded connector assembly 7 is shown already threaded together with the internal housing thread 20 of the upper base mount notched or gear mesh ridged pivotal head 3. The outer thread 5 of the male pin threaded assembly 23 is shown threaded together with the internal thread 19 of the hollow barrel 4 of the antenna housing assembly, with the shielding of the coaxial cable 8 of the antenna connected to the secondary conductor pin 14.

In addition, the internal thread 19 of the hollow barrel 4 of the antenna housing assembly is also threaded onto the external thread 21 of the upper base mount notched or gear mesh ridged pivotal head 3. This establishes the connection of the secondary conductive path from the shielding of the coaxial cable/wiring 8 of the antenna to the coaxial cable/wiring 8 of the vessel, thereby utilizing the hollow barrel 4 as the conductive pathway. The set screw 16 will complete the assembly, as it is shown threaded through the hollow threaded barrel 4 and into the upper base mount notched or gear mesh ridged pivotal head 3, thus locking the assembly together as a solid inseparable unit.

The foregoing discussion discloses and describes merely exemplary embodiment of the present invention. As will be understood by those skilled in the art, the present invention may be embodied in other specific forms without departing from the spirit or essential characteristics thereof Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

1. An antenna mounting apparatus for electrical connection of an antenna to a transmission medium, the mounting apparatus comprising:
an upper base mount notched or gear mesh ridged pivotal head, the upper base pivotal head including an internal housing thread and an outer thread;
a female threaded connector assembly, the female threaded connector assembly including a flanged rotatable solder point and an outside connector thread, the outside connector thread to be fastened into the internal housing thread of the upper base pivotal head; and
an upper barrel assembly including a hollow barrel housing and a flanged male pin threaded assembly, the hollow barrel housing containing an internal thread, and the flanged male pin threaded assembly containing an outer thread, such that the flanged male pin threaded assembly may be fastened to the hollow barrel housing;
wherein the upper barrel assembly is fastened to the outer thread of the upper base pivotal head, and a primary conductive core path is established by soldering an inner conductive core of the transmission medium to the flanged rotatable solder point of the female threaded connector assembly.

2. The apparatus of claim 1, wherein a secondary conductive path is established by the hollow barrel housing as a connection point between the antenna and the upper base pivotal head.

3. The apparatus of claim 1, further comprising:
a thumb hollow barrel with a thread type connector used to connect the upper base pivotal head to the transmission medium.

4. The apparatus of claim 1, wherein the antenna is adjoined to the upper barrel assembly and is affixed in place by use of a set screw.

5. The apparatus of claim 1, wherein the outside conductor thread of the female threaded connector assembly contains a non-conductive isolation.

6. A system for electrical connection of an antenna to a transmission medium, the system comprising:
a pedestal mounting base;
an antenna mount; and
a two axis pivotal point, the two axis pivotal point adjoined to the pedestal mounting base and adjoined to the antenna mount in such a manner to allow the antenna mount to be positioned and locked in multiple positions;
wherein the antenna mount includes:
an upper base mount notched or gear mesh ridged pivotal head, the upper base pivotal head including an internal housing thread and an outer thread,
a female threaded connector assembly, the female threaded connector assembly including a flanged rotatable solder point and an outside connector thread, the outside connector thread to be fastened into the internal housing thread of the upper base pivotal head, and
an upper barrel assembly including a hollow barrel housing and a flanged male pin threaded assembly, the hollow barrel housing containing an internal thread, and the flanged male pin threaded assembly containing an outer thread, such that the flanged male pin threaded assembly may be fastened to the hollow barrel housing,
wherein the upper barrel assembly is fastened to the outer thread of the upper base pivotal head, and a primary conductive core path is established by soldering an inner conductive core of the transmission medium to the flanged rotatable solder point of the female threaded connector assembly.

7. The system of claim 6, wherein a secondary conductive path is established by the hollow barrel housing as a connection point between the antenna and the upper base pivotal head

8. The system of claim 6, wherein the antenna mount further includes a thumb hollow barrel with a thread type connector used to connect the upper base pivotal head to the transmission medium.

9. The system of claim 6, wherein the antenna is adjoined to the upper barrel assembly and is affixed in place by use of a set screw.

10. The system of claim 6, wherein the outside conductor thread of the female threaded connector assembly contains a non-conductive isolation.

11. The system of claim 6, wherein the antenna mount is utilized from the group consisting of vertical, fixed, and variable position mounts.

12. The system of claim 6, wherein the transmission medium is selected from the group consisting of coaxial cable and wire.

13. A system for electrical connection of an antenna to a transmission medium, the system comprising:
an antenna mounting base;
an antenna housing assembly adjoined to the antenna mounting base;
a mounting base electrical connection allowing one or more conductive paths for the transmission medium through the antenna mounting base;
a connector used to connect the antenna mounting base to the antenna housing assembly, the connector forming a conductive path from the antenna mounting base to the antenna housing assembly.
